(19) United States
(12) Patent Application Publication
(10) Pub. No.: US 2019/0228739 A1
(43) Pub. Date: Jul. 25, 2019

(54) DISPLAY DEVICE CONTROL SYSTEM, CONTROL DEVICE, CONTROL METHOD AND DISPLAY DEVICE

(71) Applicant: Acer Incorporated, New Taipei City (TW)

(72) Inventor: Jin-Ting Kuo, New Taipei City (TW)

(73) Assignee: Acer Incorporated, New Taipei City (TW)

(21) Appl. No.: 15/976,803

(22) Filed: May 10, 2018

(30) Foreign Application Priority Data
Jan. 24, 2018 (TW) 107102440

(51) Int. Cl. G09G 5/10; G09G 5/00

(52) U.S. Cl. CPC G09G 5/10; G09G 5/006; G09G 2320/0666; G09G 2320/0626; G09G 2320/0673; G09G 2320/0613

(57) ABSTRACT

A display device control system including a display device and a control device is provided according to an embodiment of the disclosure. The display device is configured with a setting buffer and is configured to play an image on a display. The control device is configured to generate display setting information according to at least one of image information corresponding to the image and environment information corresponding to the display device and transmit the display setting information to the display device. When the display device plays the image, the display device loads the display setting information to the setting buffer and dynamically adjusts a display setting of the display according to the display setting information. In addition, a control device, a control method and a display device are provided according to the embodiments of the disclosure.

### CROSS-REFERENCE TO RELATED APPLICATION

This application claims the priority benefit of Taiwan application serial no. 107102440, filed on Jan. 24, 2018. The entirety of the above-mentioned patent application is hereby incorporated by reference herein and made a part of this specification.

### BACKGROUND OF THE DISCLOSURE

### Field of the Disclosure

The disclosure is related to a controlling mechanism of a display device, and particularly to a display device control system, a control device, a control method and a display device.

### Description of Related Art

Along with development of international business, an increasing number of companies choose to set display devices such as a remote digital signage and the like to play advertisement or promotional videos at specific places. However, local residents' lifestyle, weather, the place where the display device is located and such factors affect the image playing quality of the remote display device. Additionally, with the same environment conditions, different image content is likely to affect the image playing quality of the remote display device. Therefore, although some displays are equipped with functions of detecting brightness in an environment and can automatically adjust the brightness of display, such simple adjusting mechanism cannot effectively eliminate the negative influence brought by the external environment and the displayed image to the remote display device. Moreover, although some server products can control the remote display to be activated at a fixed time or adjust the image content on display at a fixed time, the negative influence brought by the external environment and the displayed image to the remote display device are still not taken into consideration.

### SUMMARY OF THE DISCLOSURE

The disclosure provides a display device control system, a control device, a control method and a display device, which can dynamically adjust display setting of a remote display device according to an image to be displayed and/or environment information, such that the displaying quality of the remote display device can be effectively improved.

An embodiment of the disclosure provides a display device control system that includes a display device and a control device. The display device is provided with a setting buffer and is configured to play an image on a display. The control device is configured to generate a display setting information according to at least one of an image information corresponding to the image and an environment information corresponding to the display device and transmit the display setting information to the display device. When the display device plays the image on the display, the display device loads the display setting information into the setting buffer and dynamically adjust a display setting of the display according to the display setting information.

Another embodiment of the disclosure provides a control device that is configured to remotely control display setting of a display device. The control device includes a network interface circuit and a processor circuit. The processor circuit is coupled to the network interface circuit. The processor circuit is configured to generate display setting information according to at least one of an image information corresponding to an image and an environment information corresponding to the display device and transmit the display setting information to the display device by the network interface circuit. The display setting information is configured to dynamically adjust display setting of the display device when the display device plays the image.

Another embodiment of the disclosure provides a control method that is configured to remotely control display setting of a display device. The control method includes the following steps. At least one of an image information corresponding to an image and an environment information corresponding to the display device is obtained. Display setting information is generated according to at least one of the image information and the environment information, and the display setting information is transmitted to the display device. The display setting information is configured to dynamically adjust display setting of the display device when the display device plays the image.

Another embodiment of the disclosure provides a display device that includes a display, a network interface circuit, a storage circuit, a setting buffer and a processor circuit. The display is configured to play an image. The network interface circuit is configured to receive at least one setting packet. Each of the setting packet indicates a display setting information corresponding to at least one image frame of the image. The storage circuit is configured to store the image frame and the display setting information. The processor circuit is coupled to the display, the network interface circuit, the storage circuit and the setting buffer. When the image is played on the display, the processor circuit loads the display setting information into the setting buffer and dynamically adjusts display setting of the display according to the display setting information.

In summary, according to the image information of the image to be played and/or the environment information corresponding to the display device, the display setting information can be generated and transmitted to the display device. When the image is played, the display device can load the display setting information into the setting buffer and dynamically adjust the display setting of the display according to the display setting information. In this manner, the displaying quality of the image on display can be effectively improved.

In order to make the aforementioned features and advantages of the disclosure more comprehensible, embodiments accompanying figures are described in detail below.

### BRIEF DESCRIPTION OF THE DRAWINGS

FIG. 1 is a schematic view illustrating a display device control system according to an embodiment of the disclosure.

FIG. 2 is a function block diagram of a control device and a display device according to an embodiment of the disclosure.

FIG. 3 is a schematic view of timing sequence of an image frame and a corresponding setting packet according to an embodiment of the disclosure.

FIG. 4 is a schematic diagram illustrating a flowchart of a control method according to an embodiment of the disclosure.

### DESCRIPTION OF EMBODIMENTS

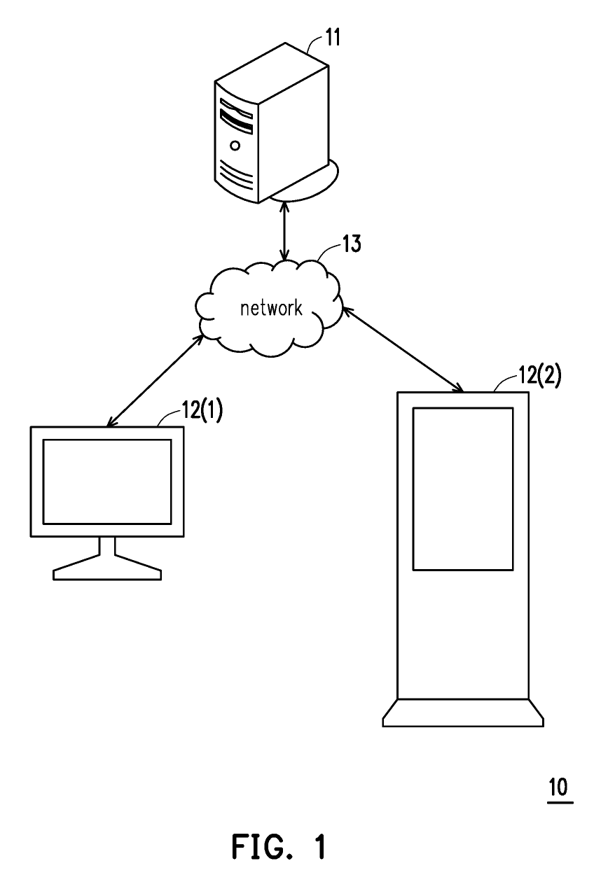

FIG. 1 is a schematic view illustrating a display device control system according to an embodiment of the disclosure. Referring to FIG. 1, a display device control system 10 includes a control device 11, a display device 12(1) and a display device 12(2). For example, the control device 11 may be a server host configured to manage the remote display device 12(1) and/or 12(2). The display devices 12(1) and 12(2) may be a smart phone, a tablet PC, a desktop display, a notebook computer, a digital signage or other types of display device respectively, and it may suffice as long as they are provided with an image displaying function. Additionally, the number of the control device 11 may be more, and the number of the display device 12(1) and the display device 12(2) may be more or less, the disclosure provides no limitation thereto.

The control device 11 is communicated with the display device 12(1) and/or 12(2) via a network 13. For example, the network 13 may refer to Internet or a local area network, which should not be construed as a limitation to the disclosure. The following embodiment describes that the system structure of the display device 12(1) is equivalent to the system structure of the display device 12(2).

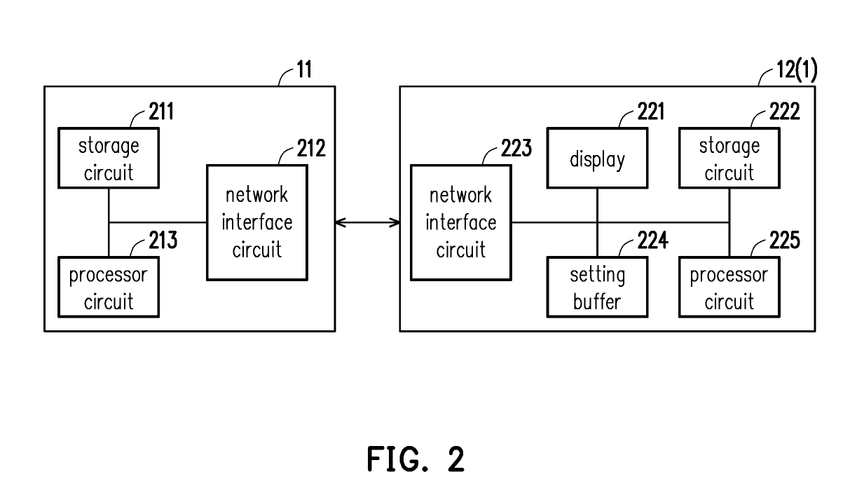

FIG. 2 is a function block diagram illustrating a control device and a display device according to an embodiment of the disclosure. Referring to FIG. 1 and FIG. 2, the control device 11 includes a storage circuit 211, a network interface circuit 212 and a processor circuit 213. The storage circuit 211 is configured to store data. For example, the storage circuit 211 may include a volatile storage medium and a non-volatile storage medium. For example, the volatile storage medium may be a random access memory (RAM), and the non-volatile storage medium may be a read-only memory (ROM), a solid-state disk (SSD) or a conventional hard disk drive (HDD) and the like. The network interface circuit 212 is configured to be connected to the network 13. For example, the network interface circuit 212 may include a wired or wireless network card.

The processor circuit 213 is coupled to the storage circuit 211 and the network interface circuit 212 and configured to control the storage circuit 211 and the network interface circuit 212. In an embodiment, the processor circuit 213 may also take control of the overall operation of the control device 11. For example, the processor circuit 213 may be a central processing unit (CPU) or other programmable general purpose or specific purpose microprocessor, a digital signal processor (DSP), a programmable controller, an application specific integrated circuit (ASIC), a programmable logic device (PLD) or other similar devices or a combination thereof.

The display device 12(1) includes a display 211, a storage circuit 222, a network interface circuit 223, a setting buffer 224 and a processor circuit 225. The display 221 is configured to display an image. For example, the display 221 may be a liquid crystal display (LCD), a light-emitting diode (LED) display, an organic light emitting display (OLED), an electro-phoretic display (EPD) or other types of display. The storage circuit 222 is configured to store data. For example, the storage circuit 222 may include a volatile storage medium and a non-volatile storage medium. For example, the volatile storage medium may be a random access memory, and the non-volatile storage medium may be a read-only memory, a solid-state disk or a conventional hard disk drive and the like. The network interface circuit 223 is configured to be connected to the network 13. For example, the network interface circuit 223 may include a wired or a wireless network card.

The setting buffer 224 includes one or more buffer memories. The setting buffer 224 is configured to temporarily store the information (also referred to as display setting information) that is configured to dynamically adjust the display setting of the display 211 when the display 221 plays image.

The processor circuit 225 is coupled to the display 221, the storage circuit 222, the network interface circuit 223 and the setting buffer 224, and is configured to control the display 221, the storage circuit 222, the network interface circuit 223 and the setting buffer 224. In an embodiment, the processor circuit 225 may also take control of the overall operation of the display device 12(1). For example, the processor circuit 225 may be a central processing unit, a graphics processing unit (GPU) or other programmable general purpose or specific purpose microprocessor, a digital signal processor, a programmable controller, an application specific integrated circuit, a programmable logic device or other similar devices or a combination thereof.

The control device 11 may generate display setting information corresponding to a specific image to be displayed by the display device 12(1) according to image information corresponding to the specific image and/or environment information corresponding to the display device 12(1), and transmit the display setting information to the display device 12(1) via the network 13. Thereafter, when the display device 12(1) plays the specific image, the display device 12(1) can dynamically adjust the display setting of the display device 12(1) simultaneously according to the display setting information, such that the displaying quality of the specific image played by the display device 12(1) disposed in the current environment can be enhanced.

Take the display device 12(1) as an example. Assume that the control device 11 is currently located in Taiwan, and the display device 12(1) is currently disposed at an outdoor square in Belgium. The control device 11 can obtain image information and/or environment information, including but not limited to the following: the image content of the specific image to be displayed by the display device 12(1), the display device 12(1) is disposed at an outdoor location when playing the specific image, the specific image is played at 10:00 A.M. in Belgium, the weather in Belgium is cloudy when the specific image is played, and the season in Belgium is winter when the specific image is played. According to at least one of the above information, the control device 11 can dynamically generate the display setting information corresponding to the specific image. In this manner, when the display device 12(1) plays the specific image, the display device 12(1) may reflect at least one of the information mentioned above to adopt an appropriate display setting, such that viewers in Belgium can have a better visual experience when watching the image displayed by the display device 12(1).

In an embodiment, the image information corresponding to the specific image may include at least one of the following: gray level color distribution information of an image frame of the image and image content identifying information of the specific image, which should not be construed as a limitation to the disclosure. The processor circuit 213 of the control device 11 may analyze the image content of the specific image and/or identify the image content of the specific image. According to the analysis on the specific image and/or the image content identifying result, the processor circuit 213 can obtain the image information corresponding to the specific image. For example, the processor circuit 213 can obtain the gray level color distribution (e.g., RGB gray level distribution) of one or more image frames in the specific image and/or the image content (e.g., image content that mainly includes scenery, people or food) of one or more image frames in the specific image.

In an embodiment, the environment information corresponding to the display device 12(1) includes at least one of the following: location information of the display device 12(1), weather information of the location of the display device 12(1) and information of local time when the display device 12(1) plays the specific image, which should not be construed as a limitation to the disclosure. For example, the location information of the display device 12(1) includes geographical information such as longitude/latitude, country (or continent), southern hemisphere or northern hemisphere as well as indoor or outdoor etc. Additionally, the weather information at the location of the display device 12(1) may include the following information such as season, temperature or whether the current weather is cloudy or sunny etc. Alternatively, in an embodiment, the environment information corresponding to the display device 12(1) may further include religious beliefs, political situation and/or viewers' color preference at the location of the display device 12(1), which should not be construed as a limitation to the disclosure. Furthermore, the environment information corresponding to the display device 12(1) may be collected from Internet via the network 13 or through other means (e.g., input by user), which should not be construed as a limitation to the disclosure.

In an embodiment, the display setting information includes at least one of Gamma curve information, gray level/color temperature information and brightness information, which should not be construed as a limitation to the disclosure. In an embodiment, the gamut range of the display and other parameters that can be used to control displaying of the display 221 may be included in the display setting information, and thus no further descriptions are incorporated herein. According to the display setting information, corresponding parameters used by the display 221 can be set.

The processor circuit 213 of the control device 11 may generate display setting information corresponding to the specific image according to the image information corresponding to the specific image to be displayed by the display device 12(1) and/or the environment information corresponding to the display device 12(1). For example, the processor circuit 213 may record parameters corresponding to the information of different properties in a table. The table may be stored in the storage circuit 211. According to the obtained image information and/or environment information, the processor circuit 213 may look up the table to obtain corresponding parameter and incorporate the obtained parameter into a specific formula to obtain the corresponding display setting information. Alternatively, the processor circuit 213 may also input the obtained parameter into another table and take the output of the table as the display setting information. Additionally, the information of different properties may be allocated with different weight values. In an embodiment, the processor circuit 213 may look up the parameter (and weight value) used to generate the display setting information according to the Table 1 below.

TABLE 1

| Type of | | | Weight |
|---|---|---|---|
| information | Property | Parameter | value |
| RGB gray | Percentage of RGB color | First Gamma curve parameter | W1 |
| level | level belonging to | | |
| distribution of | 168-256 is <10% | | |
| image | Percentage of RGB color | Second Gamma curve | |
| | level belonging to 0-64 | parameter | |
| | is <10% | | |
| | Percentage of RGB color | Third Gamma curve | |
| | level belonging to 64-168 | parameter | |
| | is between 10%-40% | | |
| image content | food | Color temperature > 6500 | W2 |
| identification | | 2.2 < Gamma parameter < 2.4 | |
| | clothing | 5500 < color | |
| | | temperature < 6500 | |
| | | 2.2 < Gamma parameter < 2.4 | |
| | Scenery | 5000 < color | |
| | | temperature < 6000 | |
| | | Gamma parameter > 2.3 | |
| Local time | 7:00~18:00 | Brightness > 800 | W3 |
| | 18:00~22:00 | 600 < Brightness < 800 | |
| | 22:00~07:00 | Brightness < 500 | |
| Location | indoor | Brightness > 700 | W4 |
| | Outdoor | Brightness < 600 | |
| Weather | Sunny | Brightness > 800 | W5 |
| | Cloudy/rain | Brightness > 700 | |
| Season | spring/autumn | 6500 > color temperature > 6000 | W6 |
| | summer | color temperature < 6000 | |
| | winter | color temperature > 7000 | |

According to Table 1, the processor circuit 213 may select a corresponding parameter (and weight value W1-W6) according to the image information corresponding to the specific image to be displayed by the display device 12(1) and/or the environment information corresponding to the display device 12(1), and generate the display setting information corresponding to the specific image accordingly.

In an embodiment, the display setting information is generated in a unit of one or more image frames. For example, the processor circuit 213 may generate one corresponding display setting information based on ten image frames in the specific image as a basic unit. Thereafter, the processor circuit 213 may generate a setting packet according to the display setting information. The setting packet is configured to indicate the display setting information corresponding to at least one image frame (e.g., ten image frames) of the specific image. In other words, at least one setting packet may be generated in corresponding to the specific image including a plurality of image frames. The processor circuit 213 may transmit the setting packet to the display device 12(1) via the network interface circuit 212.

When the network interface circuit 223 of the display device 12(1) receives the setting packet, the display setting information included in the setting packet may be stored in the storage circuit 222. When the image frame of the specific image stored in the storage circuit 222 is played, the display setting information stored in the storage circuit 222 may be loaded into the setting buffer 224. In this manner, when the display 221 plays the specific image, the display setting information in the setting buffer 224 may be used to dynamically adjust the display setting (e.g., adjust Gamma curve parameter, RGB gray level/color temperature or brightness) of the display 221, such that the playing quality of the specific image can be enhanced.

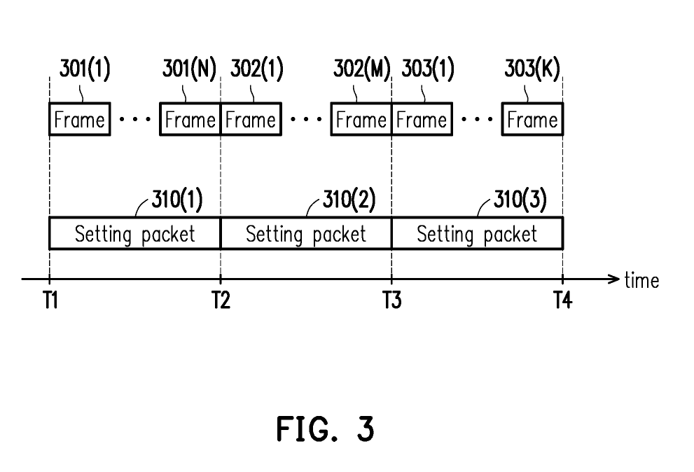

FIG. 3 is a schematic view of timing sequence of an image frame and a corresponding setting packet according to an embodiment of the disclosure. Referring to FIG. 2 and FIG. 3, assume that the specific image to be played includes frames (i.e., image frame) 301(1)-301(N), 302(1)-302(M) and 303(1)-303(K). N, M and K are positive integers. The setting packet 310(1) carries display setting information corresponding to the frames 301(1)-301(N), the setting packet 310(2) carries display setting information corresponding to the frames 302(1)-302(M), and the setting packet 310(3) carries display setting information corresponding to the frames 303(1)-303(K).

In a time range T1-T2, the image corresponding to the frames 301(1)-301(N) is played by the display 221. Accordingly, in the time range T1-T2, the display setting information carried by the setting packet 310(1) is loaded into the setting buffer 224 and used to adjust the display setting of the display 221 instantly. Thereafter, in a time range T2-T3, the image corresponding to the frames 302(1)-302(M) is played by the display 221. Accordingly, in the time range T2-T3, the display setting information carried by the setting packet 310(2) is loaded into the setting buffer 224 and used to adjust the display setting of the display 221 instantly. Thereafter, in a time range T3-T4, the image corresponding to the frames 303(1)-303(K) is played by the display 221. Accordingly, in the time range T3-T4, the display setting information carried by the setting packet 310(3) is loaded into the setting buffer 224 and used to adjust the display setting of the display 221 instantly.

In an embodiment of FIG. 1, the specific image to be played by the display device 12(1) and/or 12(2) is provided by the control device 11. For example, the control device 11 may transmit the specific image to the display device 12(1) and/or 12(2) via the network 13 in the streaming mode. Alternatively, the display device 12(1) and/or 12(2) may download the specific image from other image source device or website via the network 13. Additionally, although the preceding embodiments describe the display device 12(1) in FIG. 1 as an example, the same or similar operation may be applied to the display device 12(2), and thus no repetitions are incorporated herein.

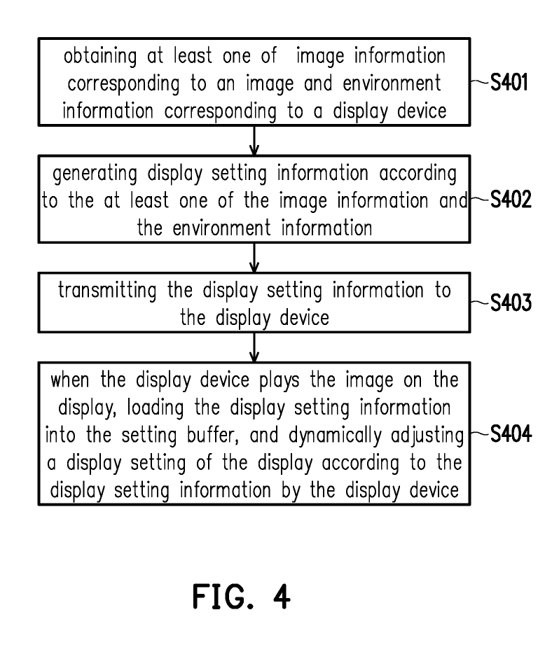

FIG. 4 is a diagram illustrating a flowchart of a control method according to an embodiment of the disclosure. Referring to FIG. 4, in step S401, at least one of the image information corresponding to the image and the environment information corresponding to the display device is obtained. In step S402, the display setting information is generated according to at least one of the image information and the environment information. In step S403, the display setting information is transmitted to the display device. For example, the display setting information may be transmitted to the display device in the form of setting packet. In step S404, when the display device plays the image on the display, the display device loads the received display setting information into the setting buffer and dynamically adjusts the display setting of the display according to the display setting information.

However, all the steps illustrated in FIG. 4 are described in details as above, and no repetitions are incorporated herein. It should be indicated that the steps illustrated in FIG. 4 may be realized as a plurality of program codes or circuits, which should not be construed as a limitation to the disclosure. In addition, the method illustrated in FIG. 4 may be adopted to work with the above-mentioned exemplary embodiments or used along, the disclosure provides no limitation thereto.

In summary of the above, according to the image information of the image to be played and/or the environment information corresponding to the display device, the display setting information may be generated and transmitted to the display device. When the image is played, the display device may load the display setting information into the setting buffer and dynamically adjust the display setting of the display according to the display setting information. In this manner, the displaying quality of the image on display can be effectively improved. In particular, by configuring an additional setting buffer in the display device, an embodiment of the disclosure may achieve the effect of instantly adjusting the display setting of the display simultaneously according to the display setting information in the setting buffer when the image is played on the display.

Although the disclosure has been disclosed by the above embodiments, the embodiments are not intended to limit the disclosure. It will be apparent to those skilled in the art that various modifications and variations can be made to the structure of the disclosure without departing from the scope or spirit of the disclosure. Therefore, the protecting range of the disclosure falls in the appended claims.

What is claimed is:

1. An display device control system, comprising:
a display device, provided with a setting buffer and configured to play an image on a display; and
a control device, configured to generate a display setting information according to at least one of an image information corresponding to the image and an environment information corresponding to the display device, and to transmit the display setting information to the display device,
wherein the display device loads the display setting information into the setting buffer and dynamically adjusts a display setting of the display according to the display setting information when the display device plays the image on the display.

2. The display device control system according to claim 1, wherein the image information comprises at least one of a gray level color distribution information of an image frame of the image and an image content identifying information of the image.

3. The display device control system according to claim 1, wherein the environment information comprises at least one of a location information of the display device, a weather information of the location of the display device and an information of local time when the display device plays the image.

4. The display device control system according to claim 1, wherein the display setting information comprises at least one of a Gamma curve information, a gray level/color temperature information and a brightness information.

5. The display device control system according to claim 1, wherein the operation that the control device generates the display setting information and transmits the display setting information to the display device comprises:
generating at least one setting packet according to the display setting information and transmitting the at least one setting packet to the display device,
wherein each of the at least one setting packet indicates a display setting information corresponding to at least one image frame of the image.

6. A control device, configured to remotely control a display setting of a display device, the control device comprising:
a network interface circuit; and
a processor circuit, coupled to the network interface circuit,
wherein the processor circuit is configured to generate a display setting information according to at least one of an image information corresponding to an image and an environment information corresponding to the display device, and to transmit the display setting information to the display device via the network interface circuit,
wherein the display setting information is configured to dynamically adjust a display setting of the display device when the display device plays the image.

7. The control device according to claim 6, wherein the image information comprises at least one of a gray level color distribution information of an image frame of the image and an image content identifying information of the image.

8. The control device according to claim 6, wherein the environment information comprises at least one of a location information of the display device, a weather information of the location of the display device and an information of local time when the display device plays the image.

9. The control device according to claim 6, wherein the display setting information comprises at least one of a Gamma curve information, a gray level/color temperature information and a brightness information.

10. The control device according to claim 6, wherein the operation that the processor circuit generates the display setting information and transmits the display setting information to the display device comprises:
generating at least one setting packet according to the display setting information and transmitting the at least one setting packet to the display device,
wherein each of the at least one setting packet indicates a display setting information corresponding to at least one image frame of the image.

11. A control method, configured to remotely control a display setting of a display device, the control method comprising:
obtaining at least one of an image information corresponding to an image and an environment information corresponding to the display device; and
generating a display setting information according to the at least one of the image information and the environment information, and transmitting the display setting information to the display device,
wherein the display setting information is configured to dynamically adjust a display setting of the display device when the display device plays the image.

12. The control method according to claim 11, wherein the image information comprises at least one of a gray level color distribution information of an image frame of the image and an image content identifying information of the image.

13. The control method according to claim 11, wherein the environment information comprises at least one of a location information of the display device, a weather information of the location of the display device and an information of local time when the display device plays the image.

14. The control method according to claim 11, wherein the display setting information comprises at least one of a Gamma curve information, a gray level/color temperature information and a brightness information.

15. The control method according to claim 11, wherein the step of generating the display setting information and transmitting the display setting information to the display device comprises:
generating at least one setting packet according to the display setting information and transmitting the at least one setting packet to the display device,
wherein each of the at least one setting packet indicates a display setting information corresponding to at least one image frame of the image.

16. A display device, comprising:
a display, configured to play an image;
a network interface circuit, configured to receive at least one setting packet, wherein each of the at least one setting packet indicates a display setting information corresponding to at least one image frame of the image;
a storage circuit, configured to store the at least one image frame and the display setting information;
a setting buffer; and
a processor circuit, coupled to the display, the network interface circuit, the storage circuit and the setting buffer,
wherein the processor circuit loads the display setting information into the setting buffer and dynamically adjusts a display setting of the display according to the display setting information when the image is played on the display.
